(19) United States
(12) Patent Application Publication
(10) Pub. No.: US 2017/0330667 A1
(43) Pub. Date: Nov. 16, 2017

(54) SOLENOID DRIVER

(71) Applicant: BorgWarner Inc., Auburn Hills, MI (US)

(72) Inventors: John SHUTTY, Clarkston, MI (US); Roberto RASTELLI, Farmington, MI (US); Philip J. MOTT, Dryden, NY (US); Miguel RAIMAO, Colorado Springs, CO (US)

(21) Appl. No.: 15/519,649

(22) PCT Filed: Oct. 9, 2015
(86) PCT No.: PCT/US2015/054848

§ 371 Date: Apr. 17, 2017

Related U.S. Application Data
(60) Provisional application No. 62/067,231, filed on Oct. 22, 2014.

(51) Int. Cl. H01F 7/18

(52) U.S. Cl. CPC H01F 7/18

(57) ABSTRACT

A solenoid driver may be provided for a solenoid with a coil selectively energized by a power supply in a first polarity. An energy storage device may be charged by the power supply. A circuit may be configured to connect the energy storage device to the coil in a second polarity that is a reverse of the first polarity whenever the power supply is selectively turned off or unexpectedly interrupted.

### CROSS-REFERENCE TO RELATED APPLICATIONS

This application claims the benefit of U.S. Provisional Application No. 62/067,231 filed Oct. 22, 2014.

### TECHNICAL FIELD

The field to which the disclosure generally relates includes latching solenoids and more particularly, to drivers for latching solenoids.

### BACKGROUND

Solenoids that latch are used in applications where the solenoid's energized position is needed for extended periods of time. The solenoid is latched in the energized position and remains there, consuming no power, until the solenoid is unlatched. To energize the solenoid an electrical pulse may be communicated to activate the solenoid's magnetic circuit which holds the solenoid in an activated position. To release the solenoid an electrical pulse with negative polarity may be communicated to degauss the magnetic circuit releasing the solenoid from the activated position.

### SUMMARY OF ILLUSTRATIVE VARIATIONS

A number of variations may include a solenoid with a coil selectively energized by a power supply in a first polarity. An energy storage device may be charged by the power supply. A circuit may be configured to connect the energy storage device to the coil in a second polarity that is a reverse of the first polarity whenever the power supply is selectively turned off or unexpectedly interrupted.

In a number of other variations, a solenoid may include a housing, with a coil in the housing. A terminal may be provided on the housing and may be connected to the coil. An armature may be responsive to energization of the coil. A circuit may be integrated with the housing and configured to energize the coil in a first polarity to move the armature to an activated position. The circuit may also be configured to energize the coil in a second polarity to move the armature to a deactivated position. Whenever a voltage signal is present at the terminal the armature may remain in or move to the activated position and whenever a voltage signal is absent at the terminal the armature may remain in or move to the deactivated position.

Other variations may include a solenoid driver for controlling a solenoid. The solenoid may include a housing, a coil in the housing, a terminal on the housing connected to the coil, and an armature responsive to energization of the coil. A power supply may be included and a lead may be connected to the terminal. An electronic controller may be programmed only to effect connection of the power supply through the lead with the terminal and disconnection of the terminal from the power supply. A circuit may be integrated with the housing between the terminal and the coil. The circuit may be configured to energize the coil in a first polarity to move the armature to an activated position, and may be configured to energize the coil in a second polarity to move the armature to a deactivated position. The armature may be latched in an activated position when the coil is energized in the first polarity and the armature may be configured to remain in the activated position when the coil is de-energized.

Other illustrative variations within the scope of the invention will become apparent from the detailed description provided herein. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a schematic illustration of a solenoid layout according to a number of variations.

FIG. 2 is a simplified electrical diagram according to a number of variations for a driver of the solenoid of FIG. 1.

### DETAILED DESCRIPTION OF ILLUSTRATIVE VARIATIONS

The following description of the variations is merely illustrative in nature and is in no way intended to limit the scope of the invention, its application, or uses.

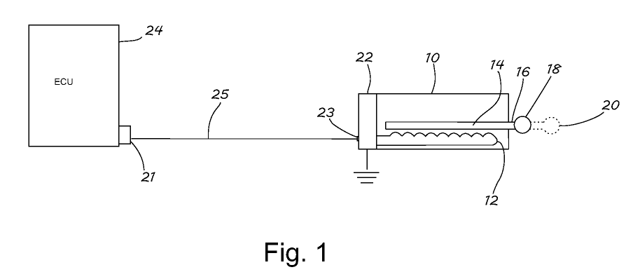

Referring to FIG. 1, a number of variations may include a solenoid 10 that has a coil 12 and an armature assembly 14. The armature assembly may include an extending rod 16 for engaging a device such as a valve ball 18 to be actuated by the solenoid 10. When electrical current is applied to the coil's winding, a magnetic field is generated. In response to the magnetic field, the armature translates from the deactivated position to an activated position 20.

When the supply of current is stopped, a residual magnetic field remains in the ferromagnetic elements of the solenoid 10 as is known in the art. The magnetic field holds the armature in the activated position with no current flowing to coil 12. In this manner the solenoid stays in the activated position 20 without an ongoing supply of power after activation.

Solenoid 10 includes a control circuit 22 integrated in the same hardware package or housing as the solenoid. Control circuit 22 is in communication with electronic controller 24 through single conductor lead 25 connected between terminal 21 and terminal 23 for the supply of positive voltage. Electronic controller 24 provides either a positive voltage output signal or no signal. Control circuit 22 may be grounded at 28 to enable a closed circuit.

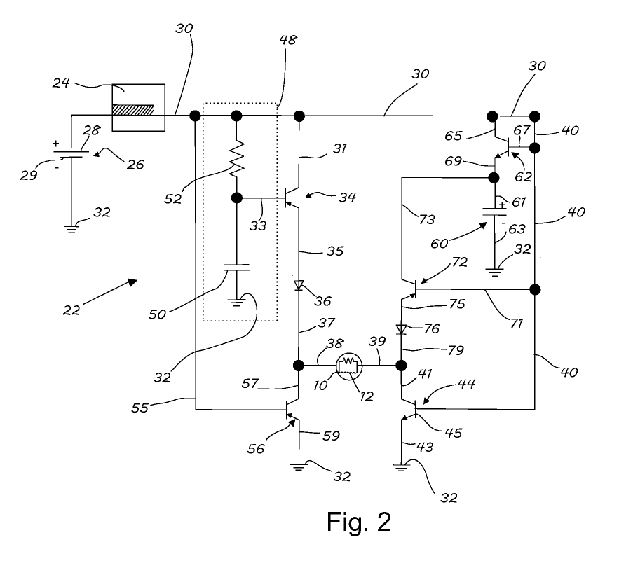

Referring to FIG. 2 a number of variations may include the control circuit 22. The simplified electrical circuit 22 schematically depicts the supply of current to the solenoid coil 12. Resistors that one skilled in the art may include may be omitted from FIG. 2 for simplicity. A direct current power supply 26 is selectively connected to the coil 12 through the effect of electronic controller 24. The positive pole 28 of power supply 26 is selectively connectable according to the control logic of electronic controller 24 to conductor 30 and the negative pole 29 is connected to ground 32. Controller 24 may be programmed to activate solenoid 10 to effect the needs of the application within which the solenoid is used.

To energize the solenoid's coil 12, electronic controller 24 effects the application of voltage to conductor 30, which passes current through to conductor 31, transistor 34, diode 36, and conductor 38 to solenoid 10. At solenoid 10 the current is applied to coil 12, establishing a magnetic field in the ferromagnetic elements of the solenoid 10 with a polarity to move the solenoid's armature to an activated position. Transistor 34 may be a PNP semiconductor device with its base connected to conductor 33, collector connected to conductor 31, and emitter connected to conductor 35. When voltage is applied to the collector from conductor 31, current flows to the emitter and from conductor 31 to conductor 35. Diode 36 may be a PN semiconductor device that conducts current in only one direction from its anode to its cathode. Diode 36 may be positioned in circuit 22 with its anode connected to conductor 35 and its cathode connected to conductor 37.

The opposite ends of coil 12 are connected to conductors 38 and 39. The circuit for energizing coil 12 may be completed to ground 32 through conductor 39, conductor 41, transistor 44 and conductor 43. Transistor 44 may be a NPN semiconductor device with its base connected to conductor 40, its collector connected to conductor 41 and its emitter connected to conductor 43. With voltage applied to its base through conductor 30, and conductor 40, current flows through transistor 44 and conductors 41 and 43 to ground 32. With solenoid 10 activated, a residual magnetic field established by the supply of current remains and holds the solenoid's armature in the activated position. The current that established the magnetic field included a positive voltage signal at the end of coil 12 that is connected to conductor 38, with conductor 39 connected to ground 32. After an initial pulse to activate the solenoid, current is no longer needed to maintain the solenoid in the activated position.

As shown in FIG. 2, a number of variations of the electrical circuit 22 may include a resistor-capacitor timing circuit 48 that is connectable to power supply 26 for charging capacitor 50 through resistor 52. Resistor 52 may have a resistance of approximately 1 M. When the electronic controller applies voltage to conductor 30, current is metered through resistor 52 and applied to capacitor 50 which charges toward steady state as the voltage across it approaches the supplied voltage from power supply 26 and current flow approaches zero. This charges the capacitor, which may have a capacitance of approximately 0.1 microfarads. With the increase in voltage of charged capacitor 50 applied to conductor 33, and there through to the base of transistor 34, the flow of current through the transistor may be impeded or blocked. As a result, the initial voltage signal from power supply 26 results in a current pulse that latches solenoid 10 and charges capacitor 50. With solenoid 10 latched, current is no longer needed to hold it in an activated position, and the blocking of current through transistor 34 means unneeded current is not consumed by the solenoid 10. As current reduces, voltage continues to be applied to the conductor 30 by controller 24. The duration of the pulse of current to latch solenoid 10 is determined by the sizes of the resistor 52 and capacitor 50 in the resistor-capacitor timing circuit 48.

Circuit 22 may also include transistor 56 which may be a PNP semiconductor device with its base connected to conductor 55, collector connected to conductor 57 and emitter connected to conductor 59. When voltage is applied by controller 24 to conductor 30 and there through to conductor 56, the voltage at the base of transistor 56 blocks the flow of current to ground 32 through conductor 59.

To release the solenoid 10 from the activated state, the residual magnetic field must be eliminated or “degaussed.” To accomplish degaussing, a current with reverse polarity may be selectively applied to the coil 12. Circuit 22 may include an energy storage device which may be a capacitor 60 with its positive terminal connected to conductor 61 and its negative terminal connected to conductor 63. Capacitor 60 may be sized to effect unlatching of the solenoid 10 and may have a capacitance of approximately 100 microfarads. In order to unlatch solenoid 10, capacitor 60 may be charged and selectively discharged to apply a current having a polarity that is the reverse of the current used to latch the solenoid 10.

The current used to charge capacitor 60 may be supplied through transistor 62 which has its base connected to conductor 67, its collector connected to conductor 65 and its emitter connected to conductor 69. Transistor 62 may be a NPN semiconductor device. When controller 24 effects voltage at conductor 30, the signal continues to conductor 40, conductor 67 and to the base of transistor 62. This allows current to flow from the collector to the emitter and from conductor 65 to conductor 69 and there through to conductor 61 to charge capacitor 60. With voltage at conductor 30, capacitor 60 charges toward steady state as the voltage across it approaches the supplied voltage from power supply 26 and current flow approaches zero. Voltage may remain on but current and the consumption of power drops to near zero as the capacitor is charged.

The voltage signal also passes through conductor 40 and conductor 71 to base of transistor 72. Transistor 72 may be a PNP semiconductor device with its base connected to conductor 72, its collector connected to conductor 73 and it emitter connected to conductor 75. Conductor 75 may be connected through diode 76, conductor 79 and conductor 39, with coil 12 of solenoid 10. With the controller 24 applying voltage through conductors 30, 40 and 71 to the base of transistor 72, current cannot flow between collector and emitter or from conductor 73 to conductor 75. This maintains the charge in capacitor 60. Diode 76 may be a PN semiconductor device that conducts current in only one direction from its anode to its cathode. Diode 76 may be positioned with its anode connected to conductor 75 and its cathode connected to conductor 79.

Transistor 72 may be used to connect the positive side of capacitor 60 with coil 12. The current that established the magnetic field latching solenoid 10 included a positive voltage at the end of coil 12 that is connected to conductor 38 with conductor 39 connected to ground 32. To degauss the magnetic circuit, conductor 39 may be connected to a positive voltage source and conductor 38 may be connected to ground 32. This will apply current to the coil 12 with a polarity that is the reverse of the current applied to activate the solenoid from the power supply 26. The reverse polarity current eliminates the residual magnetic field in the ferromagnetic elements of the solenoid, unlatching and allowing the armature assembly 20 to return to the deactivated state.

Unlatching current may be applied to the coil 12 when the controller 24 de-energizes the circuit 22, ending the supply of voltage to conductor 30. The absence of a voltage signal at the bases of transistors 56 and 72 allows the flow of current between collector and emitter, and at the bases of transistors 62 and 44 blocks the flow of current between collector and emitter. Therefore, when controller 24 interrupts voltage, current may flow from the positive side of capacitor 60 to the opposite end of the coil 12 from which the latching current was supplied. More specifically, current flows from charged capacitor 60 through conductor 73, transistor 72, conductor 75, diode 76, conductor 79, and conductor 39 to coil 12. The opposite end of coil 12 is connected to ground 32 through conductor 38, conductor 57, transistor 56 and conductor 59. Current may flow through the coil 12 with the opposite polarity used to latch the solenoid 10 and the magnetic circuit is degaussed, releasing the solenoid from the activated state. Through this mechanism, a latching solenoid that consumes little or no power when activated may be installed in an application with a controller programmed to control a conventional solenoid that operates in a bi-state mode where an energized circuit results in an activated solenoid and a de-energized circuit results in a deactivated solenoid. This may allow the substitution of a latching solenoid to reduce power consumption without other changes in the product within which the solenoid is employed, and without reprogramming the controller.

Upon an unexpected loss of power in the circuit 22 such as by an interruption in the lead 25, the capacitor 60 operates to degausses the residual magnetic field and ensures the solenoid moves to the de-energized or default state as if the controller 24 had commanded deactivation. In this manner a fail-safe means of operation is provided wherein the loss of supplied voltage will return the solenoid to the deactivated state. To maximize the fail safe nature of the device, control circuit 22 is integrated in the same hardware package as the solenoid 10. This also simplifies substituting the latching solenoid for a conventional solenoid in a given application.

The following description of variants is only illustrative of components, elements, acts, products and methods considered to be within the scope of the invention and is not in any way intended to limit such scope by what is specifically disclosed or not expressly set forth. Components, elements, acts, products and methods may be combined and rearranged other than as expressly described herein and still are considered to be within the scope of the invention.

Variation 1 may include a solenoid with a coil selectively energized by a power supply in a first polarity. An energy storage device may be charged by the power supply. A circuit may be configured to connect the energy storage device to the coil in a second polarity that is a reverse of the first polarity whenever the power supply is selectively turned off or unexpectedly interrupted.

Variation 2 may include a solenoid as stated in variation 1 wherein the solenoid is latched in an activated position when the power supply energizes the coil.

Variation 3 may include a solenoid as stated in variation 2 wherein an initial pulse of current latches the solenoid in the activated position and wherein the circuit is configured to reduce current consumption after the initial pulse to a near zero level.

Variation 4 may include a solenoid as stated in variation 3 wherein voltage in the circuit remains constant while current consumption is reduced.

Variation 5 may include a solenoid as stated in any of variations 1 through 4 wherein the solenoid includes a housing and the circuit is integrated into the housing.

Variation 6 may include a solenoid as stated in any of variations 1 through 5 wherein the power supply is energized by an electronic controller and wherein the electronic controller is programmed to only effect the on/off state of the power supply.

Variation 7 may include a solenoid as stated in any of variations 1 through 6 wherein the coil includes a first end selectively connected to a positive terminal of the power supply and a second end selectively connected to a positive terminal of the energy storage device.

Variation 8 may include a solenoid as stated in any of variations 1 through 7 that may include an armature that is latched in the activated position by a magnetic field.

Variation 9 may include a solenoid as stated in variation 8 wherein a lead extends between the electronic controller and the solenoid and wherein an interruption in the lead demagnetizes the magnetic field.

Variation 10 may include a solenoid having a housing, with a coil in the housing. A terminal may be provided on the housing and be connected to the coil. An armature may be responsive to energization of the coil. A circuit may be integrated with the housing and configured to energize the coil in a first polarity to move the armature to an activated position. The circuit may also be configured to energize the coil in a second polarity to move the armature to a deactivated position. Whenever a voltage signal is present at the terminal the armature may remain in or move to the activated position and whenever a voltage signal is absent at the terminal the armature may remain in or move to the deactivated position.

Variation 11 may include a solenoid as stated in variation 10 wherein the solenoid is latched in the activated position when the coil is energized.

Variation 12 may include a solenoid as stated in variation 11 wherein an initial pulse of current may latch the solenoid in the activated position and the circuit may be configured to reduce current consumption after the initial pulse to a near zero level.

Variation 13 may include a solenoid as stated in variation 12 wherein voltage in the circuit may remain constant while current consumption is reduced.

Variation 14 may include a solenoid as stated in any of variations 10 through 13 wherein an electronic controller may effect power supply to the terminal and wherein the electronic controller may be programmed to only effect the on/off state of the power supply.

Variation 15 may include a solenoid as stated in any of variations 10 through 14 wherein the coil may include a first end connected to the terminal and a second end selectively connected to a positive terminal of an energy storage device.

Variation 16 may include a solenoid as stated in any of variations 14 through 15 wherein a lead may extend between the electronic controller and the terminal and wherein an interruption in the lead unlatches the armature from the activated position.

Variation 17 may include a solenoid driver for controlling a solenoid. The solenoid may include a housing, a coil in the housing, a terminal on the housing connected to the coil, and an armature responsive to energization of the coil. A power supply may be included and a lead may be connected to the terminal. An electronic controller may be programmed only to effect connection of the power supply through the lead with the terminal and disconnection of the terminal from the power supply. A circuit may be integrated with the housing between the terminal and the coil. The circuit may be configured to energize the coil in a first polarity to move the armature to an activated position, and may be configured to energize the coil in a second polarity to move the armature to a deactivated position. The armature may be latched in an activated position when the coil is energized in the first polarity and the armature may be configured to remain in the activated position when the coil is de-energized.

Variation 18 may include a solenoid driver as stated in variation 17 wherein voltage in the circuit may remain constant while the armature is latched in the activated position.

Variation 19 may include a solenoid driver as stated in variation 18 wherein when the electronic controller effects disconnection of the terminal from the power supply, the circuit may be configured to unlatch the armature allowing it to move to the deactivated position.

Variation 20 may include a solenoid driver as stated in variation 17 or 18 wherein upon any interruption of the lead disconnecting the power supply from the terminal, the circuit may be configured to unlatch the armature allowing it to move to the deactivated position.

The above description of select variations within the scope of the invention is merely illustrative in nature and, thus, variations or variants thereof are not to be regarded as a departure from the spirit and scope of the invention.

What is claimed is:

1. A solenoid comprising: a coil selectively energized by a power supply in a first polarity; an energy storage device charged by the power supply; a circuit configured to connect the energy storage device to the coil in a second polarity that is a reverse of the first polarity whenever the power supply is selectively turned off or unexpectedly interrupted.

2. A solenoid according to claim 1 wherein the solenoid is latched in an activated position when the power supply energizes the coil.

3. A solenoid according to claim 2 wherein an initial pulse of current latches the solenoid in the activated position and wherein the circuit is configured to reduce current consumption after the initial pulse to a near zero level.

4. A solenoid according to claim 3 wherein voltage in the circuit remains constant while current consumption is reduced.

5. A solenoid according to claim 3 wherein the solenoid includes a housing and the circuit is integrated into the housing.

6. A solenoid according to claim 5 wherein the coil is energized by an electronic controller and wherein the electronic controller is programmed to only effect the on/off state of the power supply.

7. A solenoid according to claim 6 wherein the coil includes a first end selectively connected to a positive terminal of the power supply and a second end selectively connected to a positive terminal of the energy storage device.

8. A solenoid according to claim 7 further comprising an armature that is latched in the activated position by a magnetic field.

9. A solenoid according to claim 8 wherein a lead extends between the electronic controller and the solenoid and wherein an interruption in the lead demagnetizes the magnetic field.

10. A solenoid comprising: a housing; a coil in the housing; a terminal on the housing connected to the coil; an armature responsive to energization of the coil; and a circuit integrated with the housing and configured to energize the coil in a first polarity to move the armature to an activated position, and configured to energize the coil in a second polarity to move the armature to a deactivated position; wherein whenever a voltage signal is present at the terminal the armature remains in or moves to the activated position and whenever a voltage signal is absent at the terminal the armature remains in or moves to the deactivated position.

11. A solenoid according to claim 10 wherein the solenoid is latched in the activated position when the coil is energized.

12. A solenoid according to claim 11 wherein an initial pulse of current latches the solenoid in the activated position and wherein the circuit is configured to reduce current consumption after the initial pulse to a near zero level.

13. A solenoid according to claim 12 wherein voltage in the circuit remains constant while current consumption is reduced.

14. A solenoid according to claim 13 wherein an electronic controller effects power supply to the terminal and wherein the electronic controller is programmed to only effect the on/off state of the power supply.

15. A solenoid according to claim 14 wherein the coil includes a first end connected to the terminal and a second end selectively connected to a positive terminal of an energy storage device.

16. A solenoid according to claim 15 wherein a lead extends between the electronic controller and the terminal and wherein an interruption in the lead unlatches the armature from the activated position.

17. A solenoid driver for controlling a solenoid that includes a housing, a coil in the housing, a terminal on the housing connected to the coil, and an armature responsive to energization of the coil, comprising: a power supply; a lead connected to the terminal; an electronic controller programmed only to effect connection of the power supply through the lead with the terminal and disconnection of the terminal from the power supply; a circuit integrated with the housing between the terminal and the coil and configured to energize the coil in a first polarity to move the armature to an activated position, and configured to energize the coil in a second polarity to move the armature to a deactivated position; wherein the armature is latched in an activated position when the coil is energized in the first polarity and the armature is configured to remain in the activated position when the coil is de-energized.

18. A solenoid driver according to claim 17 wherein voltage in the circuit remains constant while the armature is latched in the activated position.

19. A solenoid driver according to claim 18 wherein when the electronic controller effects disconnection of the terminal from the power supply, the circuit is configured to unlatch the armature allowing it to move to the deactivated position.

20. A solenoid driver according to claim 19 wherein upon any interruption of the lead disconnecting the power supply from the terminal, the circuit is configured to unlatch the armature allowing it to move to the deactivated position.
